(19) United States
(12) Patent Application Publication
(10) Pub. No.: US 2020/0100143 A1
(43) Pub. Date: Mar. 26, 2020

(54) TRAFFIC SHAPING METHODS AND APPARATUS FOR PROVIDING WIRELESS CONTENTION REDUCTION AND AIRTIME FAIRNESS FOR MULTIMEDIA TRAFFIC FLOWS IN A WIRELESS NETWORK

(71) Applicant: Cisco Technology, Inc., San Jose, CA (US)

(72) Inventors: Sergio MENA, Saubraz (CH); Lorenzo GRANAI, Crissier (CH); Jerome HENRY, Pittsboro, NC (US); Malcom Muir SMITH, Richardson, TX (US)

(21) Appl. No.: 16/137,419

(22) Filed: Sep. 20, 2018

(51) Int. Cl. H04W 28/08; H04W 28/02

(52) U.S. Cl. CPC H04W 28/08; H04W 28/0289

(57) ABSTRACT

In one illustrative example, a wireless access point (AP) for use in a wireless network is configured to receive data packets of a multimedia traffic flow (e.g. a video flow) intended for delivery to a wireless mobile device in the wireless network. If an incoming data rate of the data packets is too large, wireless collisions and interference in the wireless network may be prevalent. Accordingly, a traffic shaping process may be performed on the data packets, where the data packets are queued in a buffer and scheduled for output from the buffer at a target data rate. The target data rate may be derived from the incoming data rate and one or more communication-related parameters (e.g. channel utilization) associated with the flow.

### TECHNICAL FIELD

The present disclosure relates generally to traffic shaping techniques for use in providing wireless contention reduction and airtime fairness for multimedia traffic flows in a wireless network.

### BACKGROUND

There is a need for improving the quality of experience (QoE) for multimedia content delivered to and/or from wireless mobile devices operating in wireless networks, wherein wireless collisions and interference may be significant sources of degradation.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1A is an illustrative representation of a communication system which includes a communication network (e.g. a public network, such as the Internet) within which a plurality of wireless mobile devices may access services via a mobile network (e.g. a 4G, LTE-based network) or a wireless network (e.g. a Wi-Fi network), and wherein one of the wireless mobile devices may receive a multimedia traffic flow via the mobile network;

FIG. 1B shows a scenario in the communication system of FIG. 1A, illustrating an (e.g. sudden) offloading of the multimedia traffic flow involving the wireless mobile device from the mobile network to the wireless network, which may be accommodated with use of at least some implementations of the present disclosure;

FIG. 1C shows the scenario in the communication system of FIG. 1B, but further illustrating increased wireless collisions and interference amongst the wireless mobile devices as a result of a full (and/or excessive) offloading of the multimedia traffic flow, without use of techniques of the present disclosure;

FIG. 1D shows the scenario in the communication system of FIG. 1B, but further illustrating reduced or eliminated wireless collisions and interference as a result of a partial or fractional offloading of the multimedia traffic flow, which may be provided for with use of at least some techniques of the present disclosure;

FIG. 2 is an example of a wireless medium access control (MAC) mechanism for wireless contention-based access to the wireless network via the wireless AP;

FIG. 3 is an illustrative representation of a system for use in providing wireless contention reduction and/or airtime fairness with use of traffic shaping processes for multimedia traffic flows according to some implementations of the present disclosure;

FIG. 4 is a flowchart for describing a method for use in providing wireless contention reduction and/or airtime fairness with use of a traffic shaping process for multimedia traffic flows according to some implementations of the present disclosure;

FIG. 5 is an illustrative representation of a traffic shaping process for multimedia traffic flows according to some implementations of the present disclosure, where the traffic shaping process may be at least part of an enforcement process of FIG. 3 and/or for use in the method of FIG. 4;

FIG. 6 shows example graphs related to the traffic shaping process 500 of FIG. 5;

FIG. 7 is a flowchart for describing a method for use in providing wireless contention reduction and/or airtime fairness with use of a traffic shaping process for multimedia traffic flows according to some implementations of the present disclosure;

FIG. 8 is a table which provides a mapping of priority values to access categories (and therefore priority queues), where a given priority value is contained in a field of a data frame associated with a traffic flow; and

FIG. 9 is a flowchart for describing a method for use in providing wireless contention reduction and/or airtime fairness with use of a traffic shaping process for multimedia traffic flows according to some implementations of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

Traffic shaping methods and apparatus for use in providing reduced wireless contention and airtime fairness for multimedia traffic flows in wireless networks are described herein.

In one illustrative example, a wireless access point (AP) for use in a wireless network is configured to receive data packets of a multimedia traffic flow (e.g. a video flow) intended for delivery to a wireless mobile device operative in the wireless network. The receipt of the data packets of the flow for delivery via the wireless network may occur in response to an offloading of the multimedia traffic flow from a mobile (cellular) network to the wireless network; this may be a full or partial offloading of the multimedia traffic flow.

If an incoming data rate of the data packets is too large, a measured airtime usage associated with the multimedia traffic flow may exceed an allocated airtime fairness threshold, where wireless collisions and interference amongst one or more other wireless mobile devices served by the wireless AP may be prevalent.

Accordingly, a traffic shaping process may be performed on the data packets, where the data packets are queued in a buffer and scheduled for output from the buffer at a target data rate. The target data rate may be derived from or determined based on the incoming data rate and one or more communication-related parameters associated with the multimedia traffic flow (e.g. channel utilization, queue depth, congestion level, etc.). The outputted data packets of multimedia traffic flow may be transmitted over a wireless link at the target data rate for delivery to the wireless mobile device. Here, a congestion control mechanism utilized between a traffic source and the wireless mobile device may eventually adjust the incoming data rate in accordance with the target data rate, such that the measured airtime usage may be satisfied with respect to the allocated airtime fairness threshold, where wireless collisions and interference are reduced.

In some implementations, the target data rate may be additionally derived from or determined based on a fractional offloading factor. With partial or fractional offloading, a first portion of the multimedia traffic for the content is (still) delivered via the mobile (cellular) network and a second portion of the multimedia traffic for the content is delivered (offloaded) via the wireless network. The partial or fractional offloading to the wireless network may be performed in a progressive manner, e.g. gradually or in stages, in a step-by-step fashion. Thus, the fractional offloading factor may be progressively-increasing (or decreasing) fractional offloading factor. In some of these implementations, the progressive, partial or fractional offloading may be performed until a predetermined limit is reached.

Accordingly, a Quality of Experience (QoE) for the multimedia content associated with the multimedia traffic flow (e.g. as well as the QoE for other content associated other traffic flows in the wireless network) may be maintained or improved. With use of fractional offloading, the less expensive or “free” wireless network is advantageously used in part, preferably while maintaining the same or adequate QoE for the “total” delivered content to the wireless mobile device.

More detailed and alternative techniques and implementations are provided herein as will be described below.

### Example Embodiments

Data offloading of traffic flows from mobile (cellular) links to Wi-Fi links may be realized today. Next-generation-mobile-networking (NGMN) or 5G will increase the multiplicity of radio access network (RAN) technologies available to mobile operators and allow a selected and dynamic offload of these traffic flows. For example, a streaming video may be offloaded to Wi-Fi where available, while real-time video may stay on the mobile or 4G/Long Term Evolution (LTE) link.

Such a dynamic offload to Wi-Fi may generate an inconsistent quality of experience (QoE) to a user. This may be especially true for streaming video, due to the specific bandwidth estimation and control mechanism used for such video traffic.

To better explain, real time and streaming video flows typically use congestion control mechanisms. The protocols involved here may be or include Real Time Streaming Protocol (RTSP) (see RFC7826); Datagram Congestion Control Protocol (DCCP) (see RFC5762); Motion Pictures Experts Group (MPEG)—Dynamic Active Streaming over HTTP (DASH) (MPEG-DASH) over TCP CC (see RFC5681). In general, the congestion control mechanisms operate to adapt the sending rate to what the client estimates is a fair share of available bandwidth.

A common approach used by congestion control mechanisms is as follows. With use of an adaptive bandwidth algorithm, a server may encode video with different possible codecs, consuming different amounts of bandwidth. When the video starts, the client receives a manifest that lists the various possible codecs. Then the client downloads a first chunk of video. If the chunk takes less to be downloaded that the amount of video time it represents, the client tries the next chunk at higher bandwidth, until there is an equilibrium between the download speed and the playback time.

These algorithms work very well in wired environments, as long as they do not see increases in losses or delay or round-trip time (RTT). Thus, the algorithms will slowly increase the sending rate until they sense an increase in delay/loss information. Loss information in wired environment is highly reliable because losses are primarily due to congestion (e.g. a buffer was full and therefore a packet was dropped). The mechanisms also work well in relation to wireless links where a “controlled” bandwidth is allocated to each user.

However, the situation is very different when the bottleneck is an uncontrolled wireless link, like Wi-Fi. Unlike a wired medium, the medium in Wi-Fi is a shared medium. Thus, many losses in wireless are due to collisions and interference, not to congestion. Therefore, widely-known congestion control algorithms (e.g. the Internet Engineering Task Force or “IETF” RTP Media Congestion Avoidance Techniques or “RMCAT” group) may suffer from low wireless performance when the number of flows sharing the medium increases. This is due to the fact that congestion control algorithms will increase their rate, in an attempt to estimate the available bandwidth.

It has been shown that collisions dramatically increase when many wireless clients operate close to an access point's physical bandwidth limit. Additionally, movements in a wireless cell can modify the instantaneous bandwidth dramatically, forcing the video client to adapt while the overall throughput is still positioned around an undetected median value.

When data offloading to Wi-Fi happens, the end result may be a dramatic change in the user QoE. When pushed to the Wi-Fi link, for example, the video flows may (e.g. constantly) oscillate between suboptimal states: (a) a relatively very low sending rate (wasting bandwidth and providing low QoE to the user); and (b) a relatively very high sending rate (causing many collisions, therefore wasting bandwidth and resulting in choppy video, providing a low QoE to the user).

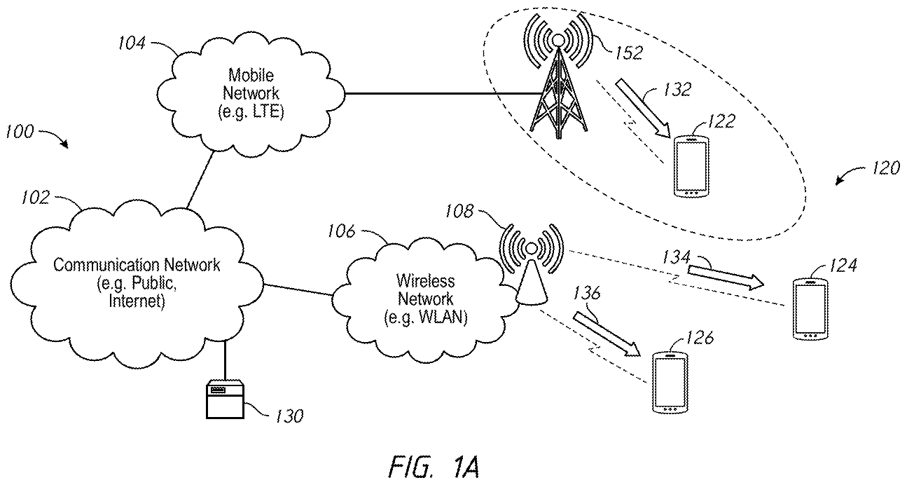

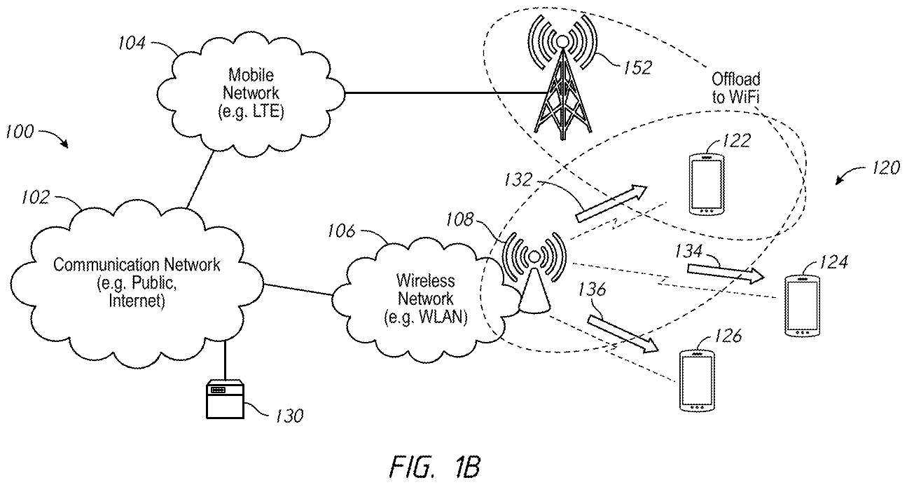

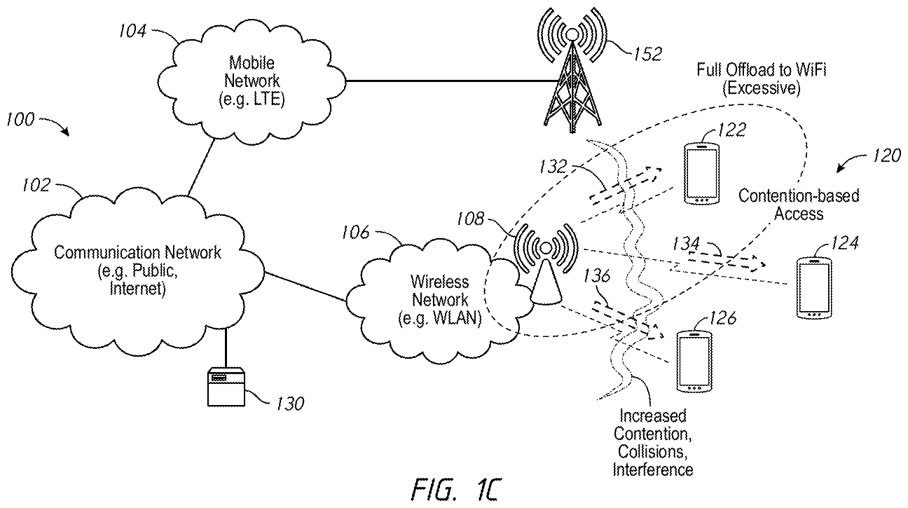

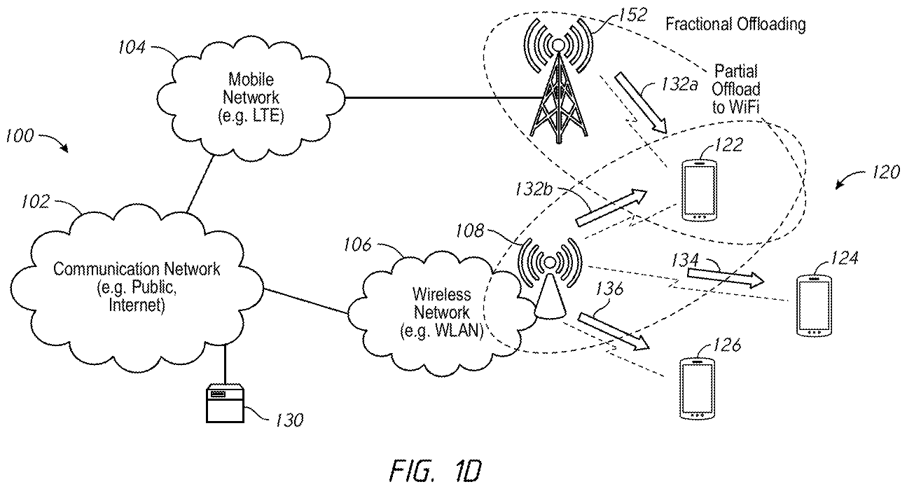

To better illustrate in relation to the drawings, FIG. 1A is an illustrative representation of a communication system 100 within which at least some implementations of the present disclosure may be provided. Communication system 100 may include a communication network 102 which may provide information and/or services. Communication network 102 may be, for example, a publicly-accessible or public communication network, such as the Internet. The information and services provided via communication network 102 may include multimedia services, such as video content delivery services. For example, one or more multimedia servers 130 of one or more multimedia services (e.g. video content delivery services) may be included in communication network 102. Multimedia server 130 may be configured to deliver multimedia traffic flows for multimedia content (e.g. video).

Access to information and services in communication network 102 may be provided, for example, via a mobile network 104 or a wireless network 106. Mobile network 104 may be a 4G, Long-Term Evolution (LTE) based mobile network or even a 5G mobile network. Wireless network 106 may be a wireless local area network (WLAN) or “Wi-Fi” network which includes one or more wireless access points (APs) 108 (e.g. IEEE 802.11). In FIG. 1A, a plurality of wireless mobile devices 120 may connect in communication network 102 to receive the information and services. Wireless mobile devices 120 (e.g. UEs or STAs) may be or include smart phones, cell phones, wireless computing devices, laptop computers, tablet computers, and the like, to name but a few. As illustrated in FIG. 1A, wireless mobile device 122 which is connected and operating in mobile network 104 may receive a multimedia traffic flow 132 for multimedia content (e.g. video). As further illustrated, wireless mobile devices 124 and 126 connected and operating in wireless network 106 may receive multimedia traffic flows 134 and 136, respectively, for multimedia content (e.g. video).

Mobile network 104 is configured to provide “controlled” wireless links for the delivery of multimedia traffic flows to wireless mobile devices (e.g. a controlled wireless link for the delivery of multimedia traffic flow 132 to wireless mobile device 122), whereas wireless network 106 is configured to provide at least somewhat “uncontrolled” wireless links for the delivery of multimedia traffic flows to wireless mobile devices (e.g. uncontrolled wireless links for the delivery of multimedia traffic flows 134 and 136 to wireless mobile devices 124 and 126).

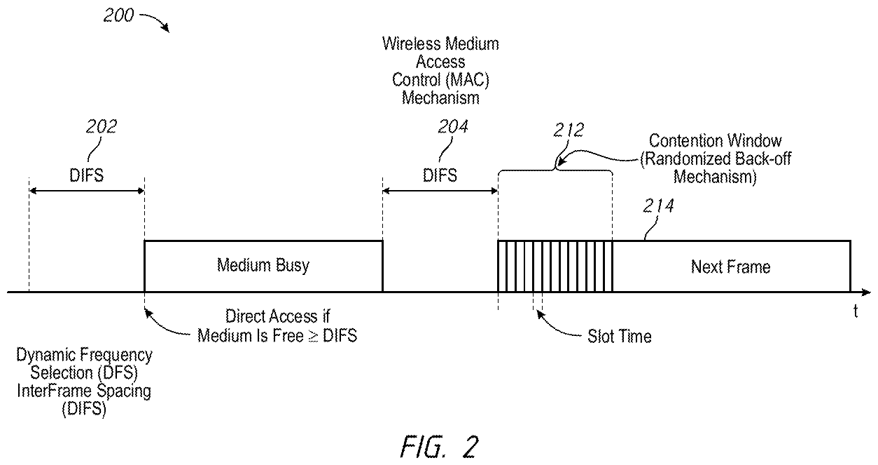

Regarding the uncontrolled wireless links, wireless network 106 having wireless AP 108 is configured to provide a wireless contention-based access for wireless mobile devices 120. Referring ahead to FIG. 2, an example of a wireless medium access control (MAC) mechanism for wireless contention-based access is shown. Mechanism 200 may include a contention window 212 for wireless contention-based access and a frame 214 for communicating data after the contention window 212. Between each contention window and frame for communication, a spacing such as a dynamic frequency selection (DFS) InterFrame Spacing (DIFS) may be provided. Each wireless mobile device may be configured to communicate in accordance with a wireless contention-based access protocol which makes use of a randomized backoff mechanism over a time period of the contention window 214.

Relatedly, referring now to FIG. 1B, the communication system 100 of FIG. 1A is shown with further illustration of a scenario involving a (e.g. sudden) offloading of the multimedia traffic flow 132 for wireless mobile device 122 from mobile network 104 to wireless network 106. In this scenario, the offloaded multimedia traffic flow 132 may cause a measured airtime usage associated with multimedia traffic flow 132 to exceed an allocated airtime fairness threshold that is allocated to the multimedia traffic flow 132 or device 122. Without additional techniques in place, this may cause disruptions of communications amongst wireless mobile devices 122, 124, and 126 due to the wireless contention-based access. As will be described herein, however, some implementations of the present disclosure may alleviate such issues.

FIG. 1C shows the scenario in the communication system of FIG. 1B, further illustrating increased wireless collisions and interference amongst the wireless mobile devices 122, 124, and 126 as a result of a full (and/or excessive) offloading of the multimedia traffic flow for wireless mobile device 122 from mobile network 104 to wireless network 106, without use of techniques of the present disclosure.

FIG. 1D shows the scenario in the communication system of FIG. 1B, but further illustrating reduced or eliminated wireless collisions and interference as a result of further use of a partial or fractional offloading of the multimedia traffic flow (a partial flow 132a through the mobile network 104, and a partial flow 132b through the wireless network 106), which may be provided for with use of at least some techniques of the present disclosure.

As mentioned in the Background section, there is a need for improving the QoE for multimedia content delivered to and/or from wireless mobile devices operating in wireless networks, wherein wireless collisions and interference may be significant sources of degradation. Note that, with use of such a shared wireless access medium, an indicated bandwidth (e.g. PHY rate) or negotiated bandwidth for multimedia traffic delivery may not be the real, available bandwidth for any given wireless mobile device. In brief, in relation to the ISO/OSI model, layer 7 (L7) processing may be unaware of limitations imposed in layer 2 (L2).

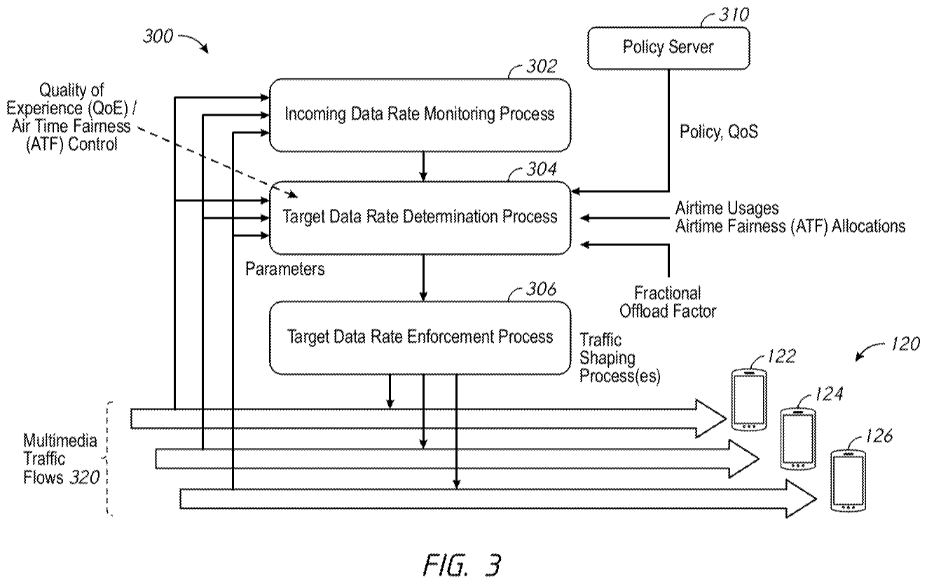

FIG. 3 is an illustrative representation of a system 300 for use in providing wireless contention reduction and/or airtime fairness with use of traffic shaping processes for multimedia traffic flows according to some implementations of the present disclosure. The multimedia traffic flows may be, for example, real-time or streaming video flows or the like.

In FIG. 3, system 300 may include an incoming data rate monitoring process 302 (“monitoring process” 302), a target data rate determination process 304 (“determination process” 304), and a target data rate enforcement process 306 (“enforcement process” 306). Monitoring process 302 may be configured to (e.g. regularly) monitor and/or obtain one or more incoming data rates of one or more multimedia traffic flows 320 associated with wireless mobile devices 120. Monitoring process 302 may be configured to utilize deep packet inspection (DPI) or the like.

Determination process 304 may be configured to determine one or more target data rates of the one or more multimedia traffic flows 320 associated with wireless mobile devices 120. The one or more target data rates may be determined based on the one or more incoming data rates and on one or more communication-related parameters associated with the one or more multimedia traffic flows 320. These communication-related parameters may be determined or measured at a network node (e.g. the wireless AP). In some preferred implementations, the one or more target data rates may be further determined based on a fractional offloading factor (e.g. see the scenario depicted in FIG. 1D); this factor may be determined by the same or different process.

Enforcement process 306 may be configured to enforce the one or more determined target data rates on the one or more multimedia traffic flows 320. The enforcement of the one or more determined target data rates may be realized with use of one or more traffic shaping processes. Each one of the multimedia traffic flows 320 may be independently controlled by enforcement process 306 (e.g. a traffic shaping process may or may not be applied to any given multimedia traffic flow, and/or the traffic shaping process may apply the same or different suitable target data rate to any given multimedia traffic flow).

Note that processes 302, 304, and 306 may be implemented in any suitable component in the system or network. For example, the processes may be implemented at or in a wireless LAN controller (WLC), a trusted WLAN gateway (GW) (TWAG), and/or a wireless AP of the wireless network. For example, determination process 304 may be implemented in and at a WLC or TWAG. Also for example, enforcement process 306 may be implemented in and ata wireless AP.

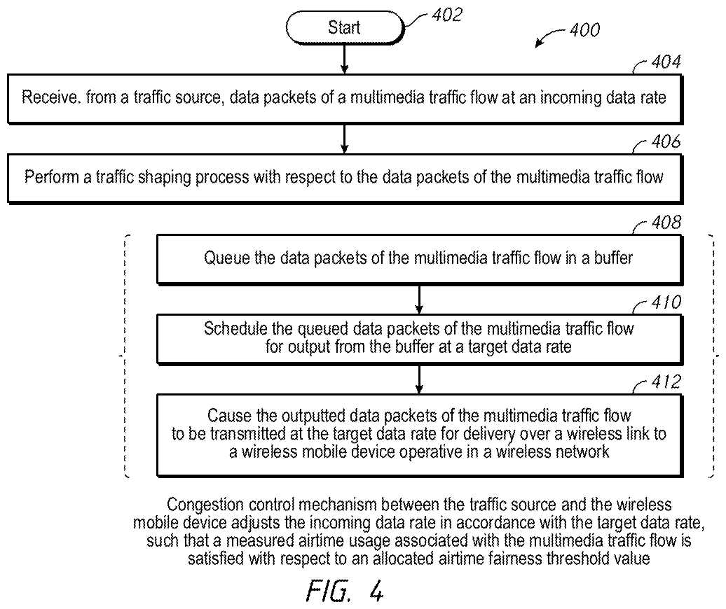

FIG. 4 is a flowchart 400 for describing a method for use in providing wireless contention reduction and/or airtime fairness with use of a traffic shaping process for multimedia traffic flows according to some implementations of the present disclosure. The multimedia traffic flows may be, for example, real-time or streaming video flows or the like. The method may be performed at a network node, such as a router, wireless router, or wireless AP of a wireless network. The method of FIG. 4 may be performed by the enforcement process 306 in system 300 of FIG. 3. The network node may include one or more processors, one or more memories coupled to the one or more processors, and one or more wireless transceivers if applicable. The method may be embodied as a computer program product (e.g. memory) including a non-transitory computer readable medium and instructions stored in the computer readable medium, where the instructions are executable on one or more processors of the network node for performing the steps of the method.

Beginning at a start block 402 of FIG. 4, data packets of a multimedia traffic flow may be received from a traffic source (step 404 of FIG. 4). The data packets may be IP data packets received at an incoming data rate, destined for delivery to a wireless mobile device operative in the wireless network. The receipt of the data packets of the multimedia traffic flow for delivery via the wireless network may be triggered in response to an offloading of the multimedia traffic flow from a mobile (cellular) network to the wireless network (see e.g. description in relation to FIGS. 1B and 1D); this may be a full or partial offloading of the multimedia traffic flow.

Note that, if the incoming data rate of the data packets is too high, a measured airtime usage associated with the multimedia traffic flow may exceed an allocated airtime fairness threshold that is allocated to the flow or device. Here, wireless collisions and interference amongst one or more other wireless mobile devices in the wireless network may be prevalent. Typically, the incoming data rate is (at least initially) set too high, as the PHY or negotiated data rate learned by the requesting wireless mobile device is typically not realizable with use of the shared wireless medium due to wireless collisions and interference.

Thus, a traffic shaping process may be performed with respect to the data packets of the multimedia traffic flow (step 406 of FIG. 4). The traffic shaping process may be performed as indicated in step 408, 410, and 412 of FIG. 4. In the traffic shaping process, the data packets of the multimedia traffic flow may be queued in a buffer (step 408 of FIG. 4) and scheduled for output from the buffer at a target data rate (step 410 of FIG. 4).

The target data rate may be derived from or determined based on the incoming data rate and one or more communication-related parameters associated with the multimedia traffic flow (e.g. channel utilization, queue depth, congestion level, etc.). These communication-related parameters may be determined or measured at a network node (e.g. the wireless AP). The target data rate may additionally or alternatively be derived from or determined based on the one or more of a client, application, or service type associated with the wireless mobile device (e.g. SSID, user or guest type, corporate or guest type, standard or premium user type, etc.).

In some preferred implementations, the target data rate may be additionally derived from or determined based on a fractional offloading factor. With partial or fractional offloading, a first portion of the multimedia traffic for the content is (still) delivered via the mobile (cellular) network and a second portion of the multimedia traffic for the content is delivered (offloaded) via the wireless network.

Accordingly, the outputted data packets of multimedia traffic flow may be transmitted over a wireless link at the target data rate for delivery to the wireless mobile device operative in the wireless network (step 412 of FIG. 4). Here, a congestion control mechanism utilized between a traffic source and the wireless mobile device may eventually adjust the incoming data rate in accordance with the target data rate, such that the measured airtime usage may be satisfied with respect to the allocated airtime fairness threshold. Here, wireless collisions and interference amongst wireless mobile devices in the wireless network may be reduced or even eliminated.

Accordingly, the QoE of the multimedia content associated with the multimedia traffic flow (and e.g. other traffic flows in the wireless network) may be improved. With use of fractional offloading, the less expensive or “free” wireless network is advantageously used in part, preferably while maintaining the same or adequate QoE for the “total” delivered content to the wireless mobile device.

The traffic shaping process for the multimedia traffic flow may be “released” when the incoming data rate is detected to be the same or substantially the same as the target data rate. However, the traffic shaping process may be repeated or continued as necessary. For example, the traffic shaping process may be repeated or continued in the event that the congestion control mechanism operates to readjust “against” the target data rate (e.g. an attempt to increase the bandwidth for multimedia delivery). As another example, the traffic shaping process may be repeated or continued in the event that a change in network conditions is detected or otherwise identified (e.g. a wireless mobile device is moved closer or further away from the wireless AP).

As even another example, the traffic shaping process may be repeated or continued if the measured airtime usage still exceeds the allocated airtime fairness threshold even after the incoming data rate is adjusted to (or closer to) the target data rate, where an updated target data rate may be determined based on an updated incoming data rate and updated communication-related parameters. Here, the congestion control mechanism will eventually adjust the updated incoming data rate in accordance with the updated target data rate, such that the measured airtime usage will be more closely satisfied with respect to the allocated airtime fairness threshold.

In some implementations, the partial or fractional offloading to the wireless network may be performed in a progressive manner, e.g. gradually or in stages, in a step-by-step fashion. Here, the fractional offloading factor may be gradually increased (or at other times gradually decreased) over time. Here, the deriving and determining of an updated target data rate based on the updated fractional offloading factor may be repeated as necessary. In some of these implementations, the progressive, partial or fractional offloading may be performed until a predetermined limit is reached.

Note that the traffic shaping process of step 406 may be enabled or triggered in response to a detection of a predetermined condition. The predetermined condition may be or include, for example, a condition where the measured airtime usage of the multimedia traffic flow exceeds the allocated airtime fairness threshold. As another example, the predetermined condition may be or include a condition where one or more communication-related parameters associated with the multimedia traffic flow (e.g. channel utilization, queue depth, congestion level, etc.) exceed a threshold.

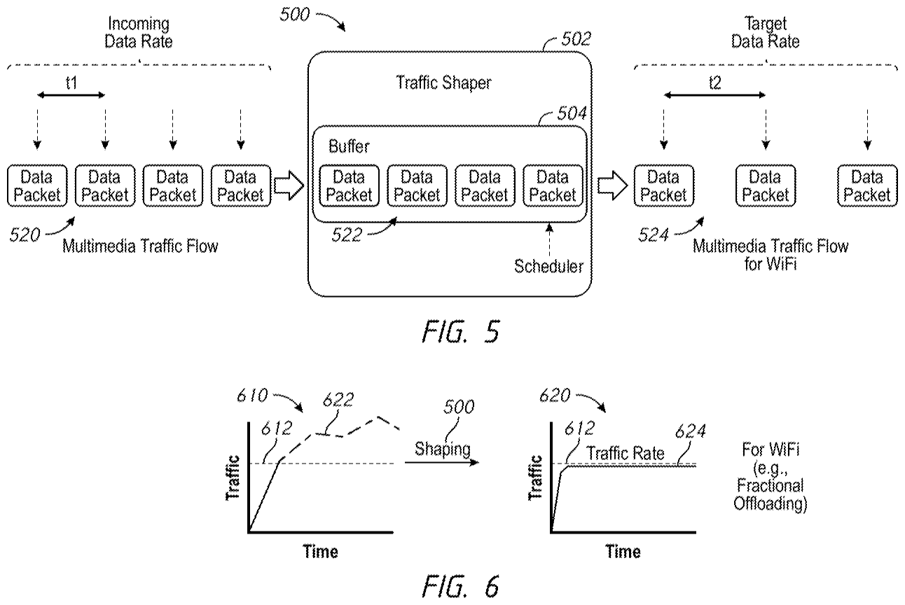

FIG. 5 is an illustrative representation of a traffic shaping process 500 for multimedia traffic flows according to some implementations of the present disclosure. Traffic shaping process 500 may be at least part of enforcement process 306 of FIG. 3 and/or for use in step 406 of FIG. 4.

As illustrated in FIG. 5, traffic shaping process 500 makes use of a traffic shaper 502 which may include a buffer 504 and a scheduler 506. Traffic shaper 502 may receive a plurality of incoming data packets 520 at an incoming data rate (e.g. t1). The incoming data packets 520 may be queued in buffer 504 as a plurality of queued data packets 522. The queued data packets 522 may be scheduled by scheduler 506 to be outputted from buffer 504 at a target data rate (e.g. t2).

The target data rate may be derived from or determined (e.g. in advance) based on the incoming data rate and one or more communication-related parameters associated with the multimedia traffic flow. The target data rate may be additionally derived from or determined based on a fractional offloading factor, in a partial or fractional offloading of the multimedia traffic to the wireless network.

A plurality outputted data packets 524 of multimedia traffic flow may be transmitted at the target data rate for delivery to a wireless mobile device in the wireless network. As illustrated, the target data rate may be less than the incoming data rate (e.g. t2>t1). This may reduce or eliminate the wireless collisions and interference in the wireless network.

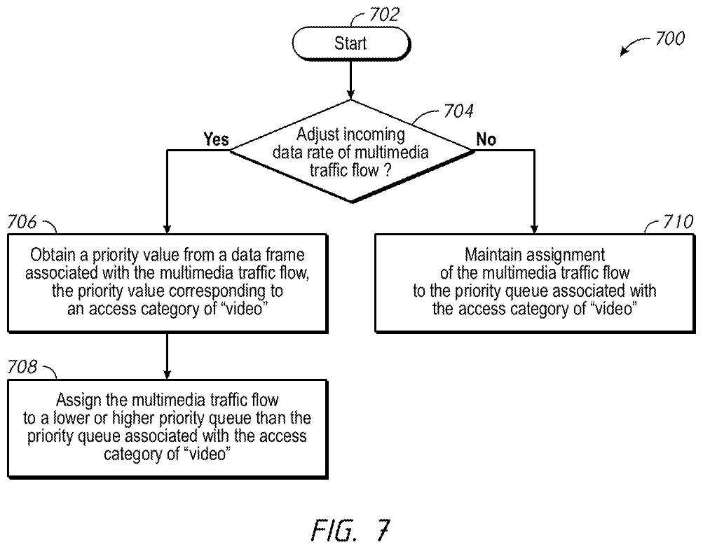

FIG. 6 shows example graphs 610 and 620 related to the traffic shaping process 500 of FIG. 5. In FIG. 6, the graph 610 of traffic-rate-versus-time is associated with incoming data packets that are input to traffic shaping process 500 is shown. In addition, the graph 620 of traffic-rate-versus-time is associated with outputted data packets that are output from the traffic shaping process 500 (FIG. 5). The incoming data packets associated with graph 610 may be received at an incoming data rate 622 which may vary and be generally greater than a target data rate 512. The outputted data packets associated with graph 620 may be outputted at an output data rate 624 which may be relatively stable and steady (i.e. relative to incoming data rate 622) and match the target data rate 612.

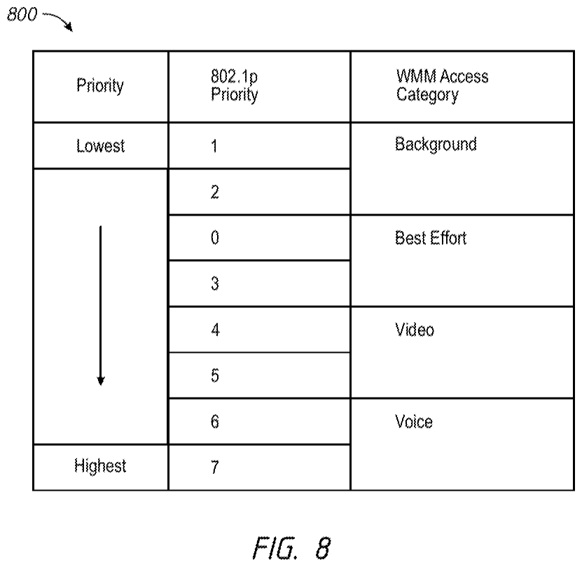

FIG. 7 is a flowchart 700 for describing a method for use in providing wireless contention reduction and/or airtime fairness with use of a traffic shaping process for multimedia traffic flows according to some implementations of the present disclosure. The multimedia traffic flows may be, for example, real-time or streaming video flows or the like. The method may be performed at a network node, such as a router, wireless router, or wireless AP. The method of FIG. 7 may be performed by the enforcement process 306 in system 300 of FIG. 3. The network node may include one or more processors, one or more memories coupled to the one or more processors, and one or more wireless transceivers if applicable. The method may be embodied as a computer program product (e.g. memory) including a non-transitory computer readable medium and instructions stored in the computer readable medium, where the instructions are executable on one or more processors of the network node for performing the steps of the method.

The method of FIG. 7 may involve a plurality of priority queues associated with different access categories of traffic flows. In such implementations, the technique may be based on Wi-Fi Multimedia (WMM), a Wi-Fi Alliance specification associated with the IEEE 802.11 wireless QoS standard. Table 800 of FIG. 8 provides a mapping of priority values to access categories (and therefore priority queues), where the priority values are contained in a field of a data frame associated with a traffic flow. In particular, WMM supports the different access categories indicated in FIG. 8: voice, video, best effort, and background. The priority value may be an 802.1D priority value contained in a QoS control field of a WMM data frame associated with the traffic flow.

Referring back to FIG. 7 and beginning at a start block 702 thereof, it is determined or otherwise identified whether an incoming data rate of a multimedia traffic flow should be adjusted (e.g. adjusted to a target data rate by a traffic shaping process) (step 704 of FIG. 7). Such determination or identification may be based on, for example, identifying that a measured airtime usage associated with the multimedia traffic flow fails to satisfy an allocated airtime fairness threshold associated with the multimedia traffic flow. As another example, such determination or identification may be based on identifying that one or more communication-related parameters associated with the multimedia traffic flow (e.g. a channel utilization parameter, a queue depth parameter, and/or a congestion level parameter) exceeds a threshold. Further, such determination or identification may be based on a combination of the above or other such detections.

As described above, a multimedia traffic flow is normally tagged with a priority value that is mapped to an access category of “video” which is associated with a priority queue that is specific to video flows. If the incoming data rate does not need to be adjusted as identified in step 704, assignment of the multimedia traffic flow to the priority queue associated with the access category of “video” is maintained (step 710 of FIG. 7). If the incoming data rate should be adjusted as identified in step 704, a priority value from a data frame associated with the multimedia traffic flow may be obtained (optional) (step 706 of FIG. 7). The priority value may be an 802.1D priority value contained in a QoS control field of a WMM data frame associated with the traffic flow. Again, for a multimedia traffic flow, the priority value is a value that is mapped to the access category of “video.” The multimedia traffic flow may be assigned to a priority queue that is different from (i.e. lower or higher than) the priority queue associated with the access category of “video” (step 708 of FIG. 7).

More specifically in step 708, if it is identified that the incoming data rate should be lowered in order to adjust to the target data rate, then the multimedia traffic flow may be assigned to a lower priority queue than the access category of “video”. For example, the multimedia traffic flow may be assigned to the priority queue mapped to the access category of “best effort” or “background.” On the other hand, if it is identified that the incoming data rate should be increased in order to adjust to the target data rate, then the multimedia traffic flow may be assigned to a higher priority queue than the access category of “video”. For example, the multimedia traffic flow may be assigned to the priority queue mapped to the access category of “voice.”

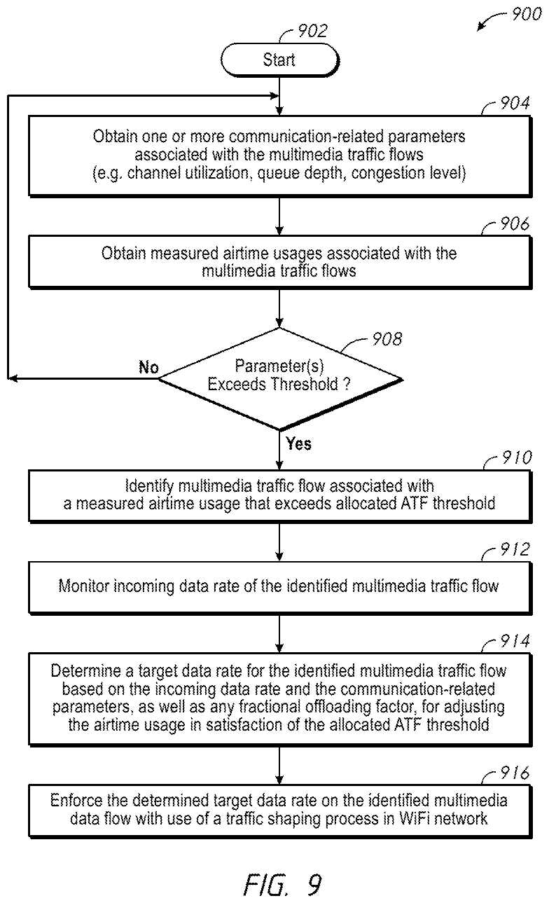

FIG. 9 is a flowchart 900 for describing a method for use in providing wireless contention reduction and/or airtime fairness with use of traffic shaping processes for multimedia traffic flows according to some implementations of the present disclosure. The multimedia traffic flows may be, for example, real-time or streaming video flows or the like. The method may be performed at a network node, such as a router, wireless router, or wireless AP, as examples. The method of FIG. 9 may be performed with use of system 300 of FIG. 3. The network node may include one or more processors, one or more memories coupled to the one or more processors, and one or more wireless transceivers if applicable. The method may be embodied as a computer program product (e.g. memory) including a non-transitory computer readable medium and instructions stored in the computer readable medium, where the instructions are executable on one or more processors of the network node for performing the steps of the method.

A plurality of wireless mobile devices may be connected in a wireless network. At least some of the wireless mobile devices may be involved in multimedia traffic flows from one or more traffic sources. In some implementations, a multimedia traffic flow may have been received for delivery via the wireless network in response to an offloading of the multimedia traffic flow from a mobile (cellular) network to the wireless network (see e.g. description in relation to FIGS. 1B and 1D); this may be a full or partial offloading of the multimedia traffic flow.

Beginning at a start block 902 of FIG. 9, one or more communication-related parameters associated with each one of the multimedia traffic flows may be obtained (step 904 of FIG. 9). Measured airtime usages associated with the multimedia traffic flows may be also obtained (step 906 of FIG. 9). If any one or more of the parameters in steps 904 and 906 exceeds a threshold value as tested in step 908, then the method proceeds to step 910; otherwise the method may proceed back to monitoring and obtaining more current communication-related parameters and measured airtime usages associated with the multimedia traffic flows in steps 904 and 906.

If any one or more of the parameters associated with any of the multimedia traffic flows in steps 904 and 906 exceeds a threshold value as tested in step 908 (e.g. a measured airtime usage of a multimedia traffic flow exceeds an allocated ATF threshold), then a multimedia traffic flow associated with a measured airtime usage that exceeds an allocated ATF threshold may be identified (step 910 of FIG. 9). The identified multimedia traffic flow may be subjected to a traffic shaping process.

Here, an incoming traffic rate of the identified multimedia traffic flow may be monitored or obtained (step 912 of FIG. 9). Note that the incoming data rate of the data packets may be too high, thereby causing a measured airtime usage associated with the multimedia traffic flow to exceed an allocated airtime fairness threshold that is allocated to the flow or device. Typically, the incoming data rate is (at least initially) set too high, as the PHY or negotiated data rate learned by the requesting wireless mobile device is typically not realizable with use of the shared wireless medium due to wireless collisions and interference.

A target data rate for the identified multimedia traffic flow may be determined (step 914 of FIG. 9). In step 914, the target data rate may be derived from or determined based on the incoming data rate and the communication-related parameters. In some implementations, the target data rate may be set to adjust the airtime usage in satisfaction of the allocated ATF threshold.

In some preferred implementations, the target data rate may be additionally derived from or determined based on a fractional offloading factor. With partial or fractional offloading, a first portion of the multimedia traffic for the content is (still) delivered via the mobile (cellular) network and a second portion of the multimedia traffic for the content is delivered (offloaded) via the wireless network.

The determined target data rate may be enforced on the identified multimedia traffic flow with use of a traffic shaping process (step 916 of FIG. 9). See e.g. FIGS. 4-8. The enforcement of the determined target data rate on the identified multimedia traffic flow with use of the traffic shaping process may have an effect on the congestion control mechanism utilized between a traffic source and the wireless mobile device. Notably, the congestion control mechanism will eventually adjust the incoming data rate in accordance with the target data rate, such that the measured airtime usage may be satisfied with respect to the allocated ATF threshold, where the wireless collisions and interference are reduced. Accordingly, the QoE of the multimedia content associated with the multimedia traffic flow (and e.g. other traffic flows in the wireless network) may be improved.

In some implementations of FIG. 9, the partial or fractional offloading to the wireless network may be performed in a progressive manner, e.g. gradually or in stages, in a step-by-step fashion. Here, the fractional offloading factor may be gradually increased (or at other times gradually decreased) over time. In some of these implementations, the progressive, partial or fractional offloading may be performed until a predetermined limit is reached. As the target data rate may be derived from or determined based on the fractional offloading factor, steps in the flowchart of FIG. 9 (e.g. steps 914 and 916) may be repeated as necessary.

Thus, as described herein, traffic shaping methods and apparatus for use in providing reduced wireless contention and airtime fairness for multimedia traffic flows in wireless networks are provided. In one illustrative example, a wireless access point (AP) for use in a wireless network is configured to receive data packets of a multimedia traffic flow (e.g. a video flow). If an incoming data rate of the data packets is too large, a measured airtime usage associated with the multimedia traffic flow may exceed an allocated airtime fairness threshold, where wireless collisions and interference amongst one or more other devices in the wireless network may be prevalent. Accordingly, a traffic shaping process may be performed on the data packets, where the data packets are queued in a buffer and scheduled for output from the buffer at a target data rate. The target data rate may be determined based on the incoming data rate and one or more communication-related parameters associated with the multimedia traffic flow (e.g. channel utilization, queue depth, congestion level, etc.). The outputted data packets of multimedia traffic flow may be transmitted over a wireless link at the target data rate for delivery to a wireless mobile device. A congestion control mechanism utilized between a traffic source and the wireless mobile device will eventually adjust the incoming data rate in accordance with the target data rate, such that the measured airtime usage may be satisfied with respect to the allocated airtime fairness threshold, where the wireless collisions and interference are reduced.

The technique may be performed in response to the multimedia traffic flow being (e.g. at least partially) offloaded from a mobile (cellular) network to the wireless network. Here, the target data rate may be additionally derived from or determined based on a fractional offloading factor, for a fractional offloading of the multimedia traffic to the wireless network. With use of fractional offloading, a first portion of the multimedia traffic for the content may (still) be delivered via the mobile (cellular) network (i.e. via an inherently controlled wireless link) and a second portion of the multimedia traffic for the content may be delivered (offloaded) via the wireless network (i.e. via an inherently uncontrolled wireless link).

Accordingly, the user QoE for the multimedia content associated with the multimedia traffic flow (e.g. as well as the QoE for other content associated other traffic flows in the wireless network) may be maintained or improved. With use of fractional offloading, the less expensive or “free” wireless network is advantageously used in part, preferably while maintaining the same or adequate QoE for the “total” delivered content.

As a further illustrative example, a wireless access point (AP) according to some implementations of the present disclosure may include one or more processors and one or more wireless transceivers coupled to the one or more processors. The one or more processors may be configured to operate with use of the one or more wireless transceivers to receive data packets of multimedia traffic flow at an incoming data rate and perform a traffic shaping process on the data packets. The traffic shaping process may be performed by at least queuing the data packets of a multimedia traffic flow in a buffer, scheduling the queued data packets of the multimedia traffic flow for output from the buffer at a target data rate, and causing the outputted data packets of the multimedia traffic flow to be transmitted over a wireless link at the target data rate for delivery to a wireless mobile device. A congestion control mechanism between a traffic source and the wireless mobile device operates to adjust the incoming data rate in accordance with the target data rate, such that a measured airtime usage associated with the multimedia traffic flow is satisfied with respect to an allocated airtime fairness threshold associated with the multimedia traffic flow.

Further, a method for use at a network node configured for use in delivery of multimedia content via a wireless network may be provided. An incoming data rate of a multimedia traffic flow may be obtained. the multimedia traffic flow may be for delivery to a wireless mobile device operative in a wireless network. One or more communication-related parameters associated with the multimedia traffic flow may be obtained. Further, a fractional offloading factor associated with a fractional offloading of the multimedia traffic flow from a mobile network to the wireless network may be obtained. A target data rate may be determined based on the incoming traffic rate, the one or more communication-related parameters, and the fractional offloading factor. The target data rate may be enforced on the multimedia traffic flow with use of a traffic shaping process, for delivery of the multimedia traffic flow to the wireless mobile device operative in the wireless network. Here, a congestion control mechanism between a traffic source and the wireless mobile device may then operate to adjust the incoming data rate in accordance with the target data rate. The target data rate may be set for adjusting a measured airtime usage associated with the flow or device to satisfy an allocated airtime fairness (ATF) threshold. The fractional offloading factor may be a progressively-increasing fractional offloading factor for a repeated determining of the target data rate.

Note that, although in some implementations of the present disclosure, one or more (or all) of the components, functions, and/or techniques described in relation to the figures may be employed together for operation in a cooperative manner, each one of the components, functions, and/or techniques may indeed be employed separately and individually, to facilitate or provide one or more advantages of the present disclosure.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms.

These terms are used to distinguish one element from another. For example, a first wireless mobile device could be termed a second wireless mobile device, and similarly, a second wireless mobile device could be termed a first wireless mobile device, without changing the meaning of the description, so long as all occurrences of the “first wireless mobile device” are renamed consistently and all occurrences of the “second wireless mobile device” are renamed consistently. The first wireless mobile device and the second wireless mobile device are both wireless mobile devices, but they are not the same wireless mobile device.

The terminology used herein is for the purpose of describing particular embodiments only and is not intended to be limiting of the claims. As used in the description of the embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a router device configured for use in wireless network,
receiving data packets of multimedia traffic flow at an incoming data rate;
performing a traffic shaping process on the data packets by:
queuing the data packets of a multimedia traffic flow in a buffer;
scheduling the queued data packets of the multimedia traffic flow for output from the buffer at a target data rate; and
causing the outputted data packets of the multimedia traffic flow to be transmitted over a wireless link at the target data rate for delivery to a wireless mobile device operative in the wireless network,
wherein a congestion control mechanism between a traffic source and the wireless mobile device operates to adjust the incoming data rate in accordance with the target data rate, such that a measured airtime usage associated with the multimedia traffic flow is satisfied with respect to an allocated airtime fairness threshold associated with the multimedia traffic flow.

2. The method of claim 1, wherein the target data rate is derived from the incoming data rate and one or more communication-related parameters, the one or more communication-related parameters including one or more of a channel utilization parameter, a queue depth parameter, and a congestion level parameter.

3. The method of claim 2, wherein the target data rate is further derived from a fractional offloading factor associated with a fractional offloading of the multimedia traffic flow from a mobile network to the wireless network.

4. The method of claim 3, wherein the fractional offloading involves only a portion of the multimedia traffic flow of the content to be delivered to the wireless mobile device via the wireless network.

5. The method of claim 1, wherein the target data rate is derived based on one or more of a client, application, or service type associated with the wireless mobile device.

6. The method of claim 1, wherein the target data rate is set to reduce or eliminate wireless collisions over the wireless link with one or more other wireless mobile devices.

7. The method of claim 1, further comprising:
performing the traffic shaping process on the data packets of the multimedia traffic flow based on identifying that the measured airtime usage associated with the multimedia traffic flow fails to satisfy the allocated airtime fairness threshold.

8. The method of claim 1, wherein performing the traffic shaping process further comprises:
assigning the multimedia traffic flow to a lower or higher priority queue than a priority queue mapped to an access category of “video.”

9. The method of claim 8, wherein assigning further comprises assigning the multimedia traffic flow to a priority queue mapped to a priority value corresponding to an access category of “best effort” or “background.”

10. The method of claim 1, wherein the router device comprises a wireless access point (AP) operative for use in the wireless network.

11. A wireless access point (AP) comprising:
one or more processors;
one or more wireless transceivers coupled to the one or more processors;
the one or more processors being configured to operate with use of the one or more wireless transceivers to:
receive data packets of multimedia traffic flow at an incoming data rate;
perform a traffic shaping process on the data packets by:
queuing the data packets of a multimedia traffic flow in a buffer;
scheduling the queued data packets of the multimedia traffic flow for output from the buffer at a target data rate; and
causing the outputted data packets of the multimedia traffic flow to be transmitted over a wireless link at the target data rate for delivery to a wireless mobile device;
wherein a congestion control mechanism between a traffic source and the wireless mobile device operates to adjust the incoming data rate in accordance with the target data rate, such that a measured airtime usage associated with the multimedia traffic flow is satisfied with respect to an allocated airtime fairness threshold associated with the multimedia traffic flow.

12. The wireless AP of claim 11, wherein the target data rate is derived based on the incoming traffic rate and one or more communication-related parameters at the wireless AP, the one or more communication-related parameters including one or more of a channel utilization parameter, a queue depth parameter, and a congestion level parameter.

13. The wireless AP of claim 11, wherein the target data rate is derived from a fractional offloading factor associated with a fractional offloading of the multimedia traffic flow from a mobile network to the wireless network.

14. The wireless AP of claim 11, wherein the target data rate is set to reduce or eliminate wireless collisions over the wireless link with one or more other wireless mobile devices.

15. The wireless AP of claim 11 wherein the one or more processors are configured to operate with the one or more wireless transceivers to perform the traffic shaping process on the data packets of the multimedia traffic flow based on identifying that the measured airtime usage associated with the multimedia traffic flow fails to satisfy the allocated airtime fairness threshold.

16. A method comprising:
at a network node,
obtaining an incoming data rate of a multimedia traffic flow to be delivered to a wireless mobile device operative in a wireless network;
obtaining one or more communication-related parameters associated with the multimedia traffic flow;
obtaining a fractional offloading factor associated with a fractional offloading of the multimedia traffic flow from a mobile network to the wireless network;
determining a target data rate based on the incoming traffic rate, the one or more communication-related parameters, and the fractional offloading factor; and
causing the target data rate to be enforced on the multimedia traffic flow with use of a traffic shaping process, for delivery of the multimedia traffic flow to the wireless mobile device operative in the wireless network.

17. The method of claim 16, wherein a congestion control mechanism between a traffic source and the wireless mobile device operates to adjust the incoming data rate in accordance with the target data rate.

18. The method of claim 16, further comprising:
repeating the determining of the target data rate based on a progressive increasing of the fractional offloading factor.

19. The method of claim 16, further comprising:
identifying that the multimedia traffic flow is associated with a measured airtime usage that exceeds an allocated airtime fairness (ATF) threshold, and
wherein the target data rate is set for adjustment of the airtime usage to satisfy the allocated ATF threshold.

20. The method of claim 16, wherein the one or more communication-related parameters include one or more of a channel utilization parameter, a queue depth parameter, and a congestion level parameter.
